(19) United States
(12) Patent Application Publication
(10) Pub. No.: US 2008/0305134 A1
(43) Pub. Date: Dec. 11, 2008

(54) Treated Bedding Cover

(75) Inventor: Kirk Lucas, Santa Fe, NM (US)

Correspondence Address: PEACOCK MYERS, P.C., 201 THIRD STREET, N.W., SUITE 1340, ALBUQUERQUE, NM, 87102, US

(73) Assignee: DREAM-EZZZ INTERNATIONAL, LLC., Santa Fe, NM (US)

(21) Appl. No.: 12/137,486

(22) Filed: Jun. 11, 2008

Related U.S. Application Data
(60) Provisional application No. 60/934,018, filed on Jun. 11, 2007.
(60) Provisional application No. 61/021,256, filed on Jan. 15, 2008.

(51) Int. Cl. A01N 25/34; A47G 9/02; A01P 7/00

(52) U.S. Cl. 424/403; 5/484

(57) ABSTRACT

A bedding cover treated with an anti-pest chemical. The cover repels or kills bedbugs, dust mites, ticks, fleas, and other pests for use in bedrooms, hotels, motels, pet beds, and the like. The cover is preferably waterproof and disposable.

### CROSS-REFERENCE TO RELATED APPLICATIONS

This application claims priority to and the benefit of the filing of U.S. Provisional Patent Application Ser. No. 60/934,018, entitled “Dream-EZZZ Sheet”, filed on Jun. 11, 2007, and U.S. Provisional Patent Application Ser. No. 61/021,256, entitled “Treated Bedding Cover”, filed on Jan. 15, 2008. The specifications thereof are incorporated herein by reference.

### BACKGROUND OF THE INVENTION

### Field of the Invention (Technical Field)

The present invention relates to a preferably disposable bedding cover which is used to prevent and eliminate the presence of pests such as bedbugs or dust mites in bedrooms, hotels, motels, pet beds, and the like.

### SUMMARY OF THE INVENTION

The present invention is a bedding cover comprising a substantially waterproof material, an adhesive applied to the material, a chemical applied to the adhesive for repelling and/or killing one or more pests, and a securing mechanism for securing the bedding cover to bedding; wherein the bedding cover is disposable and/or recyclable. The adhesive is preferably soy based and/or formaldehyde free. The chemical is preferably substantially all-natural and/or EPA approved, and is preferably applied in powder form. The material preferably comprises viscose. The securing mechanism preferably comprises elastic or a drawstring, wherein the drawstring comprises a bamboo-based fabric. The securing mechanism optionally comprises a zipper in which case the bedding cover completely encloses the bedding. The bedding cover preferably further comprises a natural ink which biodegrades or changes color after a desired period of time.

The present invention is also a method of repelling or killing one or more pests, the method comprising the steps of applying an adhesive to a substantially waterproof material, applying a pesticide to the adhesive, wherein the material, adhesive, and pesticide forms a bedding cover, drying the bedding cover, securing the bedding cover to bedding, and disposing of or recycling the bedding cover after a desired time period or number of uses. The step of applying the adhesive preferably comprises spraying the adhesive on the material. The step of applying the pesticide preferably comprises dusting on the pesticide in powder form and preferably comprises applying one pound of pesticide per 1000 square feet of material. The securing step preferably comprises tightening an elastic or drawstring. The method optionally further comprises the step of enclosing the bedding in the bedding cover, in which case the securing step preferably comprises zipping the bedding cover closed. The method preferably further comprises the step of printing a biodegradable ink on the bedding cover, the ink changing color after the desired time period. The method optionally further comprises the step of producing a disposable shopping cart handle cover from the recycled bedding cover.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1A shows an elasticized embodiment of the present invention;

FIG. 1B shows an embodiment of the present invention with a zipper-type closure;

FIG. 1C shows an embodiment of the present invention with a zipper-type closure for encasing pillows;

FIG. 2A shows a drawstring embodiment of the present invention for pet beds; and

FIG. 2B shows an embodiment of the present invention with a zipper for enclosing a pet bed.

### DETAILED DESCRIPTION OF THE INVENTION

The present invention comprises a bedding cover which is treated with a chemical for repelling or killing pests which typically infest bedrooms in homes, motels, hotels, pet beds (such as dog beds or cat beds), and other locations.

As used throughout the specification and claims, the term “pest” means any insect, bug, arachnid, germ, disease, virus, or bacteria, including ants, armyworms, bedbugs, caterpillars, chinch bugs, cutworms, fire ants, fleas, lice (and their eggs), mites, ticks, cockroaches, silverfish, spiders, boxelder bugs, crickets, sow bugs, pill bugs, ground beetles, earwigs, millipedes, centipedes, scorpions, and the like.

As used throughout the specification and claims, “bedding” means bed, futon, mattress, mattress pad, box spring, pillow, pet bed, airline seat, theater seat, baby mattress, sofa, chair, loveseat, ottoman, cushion, upholstered furniture, and the like.

The cover of the present invention can be used to cover any bedding. The cover can be made for military use and for use in prisons and jails. The cover of the present invention is preferably breathable but waterproof, thus not allowing bodily fluids to penetrate, thereby keeping the bedding sanitary. The cover is preferably disposable and is preferably fire retardant and/or flame resistant and preferably meets U.S. and California Fire Code standards. The cover is preferably a fitted cover which attaches via elastic or drawstring to the bedding, although the cover may optionally totally encase the bedding and be, for example, closed using a zipper or other fastening mechanism.

The cover may comprise any material, including but not limited to a paper-type fabric or a 50% polyester-50% rayon fabric. The material preferably comprises recycled materials and is recyclable. The cover material preferably comprises 65% polyester and 35% viscose for waterproofing. The density is preferably 95×95. The material optionally comprises nylon/viscose/polyester (a nylon fiber with high tensile strength and resilient synthetic polymers, which has desirable properties including strength, elasticity, resistance to abrasion and chemicals, low moisture absorbency, and high durability).

A chemical or pesticide which repels and/or kills one or more pests is preferably sprayed or otherwise disposed on the surface of the material, preferably on the interior surface (that is, the surface which touches the bedding, not the person or pet). The chemical is preferably all-natural (or mostly all-natural), safe, and is EPA approved. A preferred chemical is DIATECT® III, which comprises pyrethrin, diatomaceous earth (DE or silica), and Piperonyl Butoxide. The chemical typically is available as powder, and is preferably dusted on the material surface, or optionally diluted in water or another liquid before spraying. One pound of chemical is preferably used to treat 1000 square feet of material, and the duster or sprayer (if used) is preferably adjusted to provide that (or another desired) amount of coverage. The sprayer may be electrically operated, mechanically operated or manual, and may comprise a dust pump sprayer, powder mill duster, wide area applicator, Maruyama gas duster, lawn and garden sprayer, water pump pressure sprayer, compressor sprayer, wheel pump sprayer, RL Flomaster Acid Resistant Sprayer, Chapin Sprayer, or the like. Other methods of applying the chemical to the material include rolling it on, or immersing the material in the chemical.

The material is preferably cut to a desired size after the material dries, and an elastic skirt or band or a drawstring may optionally be sewn on or otherwise attached. If a drawstring is used, it preferably comprises a biodegradable bamboo fabric. Any fastener for the drawstring may be used, including but not limited to Velcro®, plastic snaps, or toggle pulls.

Because it can be difficult for the chemical, whether in powder or liquid form, to adhere to the material, prior to applying the chemical an organic spray adhesive is preferably applied to the material. The glue or adhesive is preferably natural or “green”, contains no formaldehyde and is RHOS compliant and low VAC (Volatile Organic Compound). The adhesive preferably is soy starch based, low mist, bonds fast, and has high temperature resistance. The adhesive preferably dries quickly, resists moisture and is transparent when dried. Although any adhesive may be used, two preferably adhesives are SIMALFA® or Soyad® adhesives.

The covers of the present invention are preferably inexpensive so they may be disposed of or recycled after each use. However, the covers may alternatively be used for up to six to eight months and then disposed of or recycled. Logos or other designs or instructions are preferably printed on the covers using a soy ink which biodegrades or otherwise turns color after a desired period of time (for example, six months), thereby indicating to the user that the cover has expired and must be replaced. The covers may be recycled, for example, using known heat processes into, for example, disposable shopping cart handle covers.

The regular use of the cover of the present invention means that repeated dustings or other applications of insecticide, which is typically what is performed by hotels and motel rooms, are no longer necessary. In addition, the product is preferably hypo-allergenic and/or anti-allergenic.

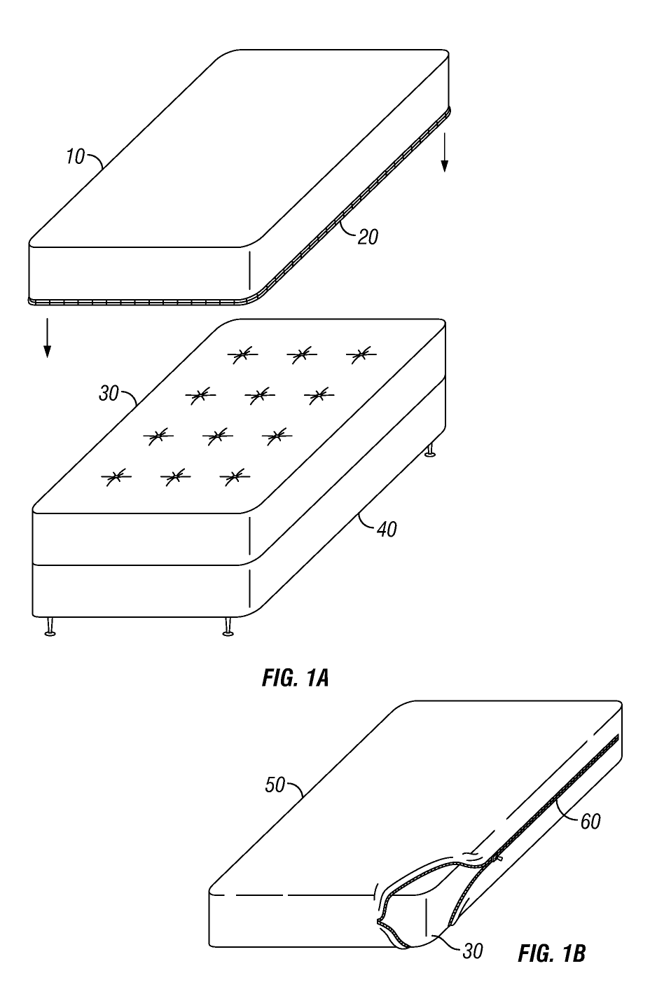

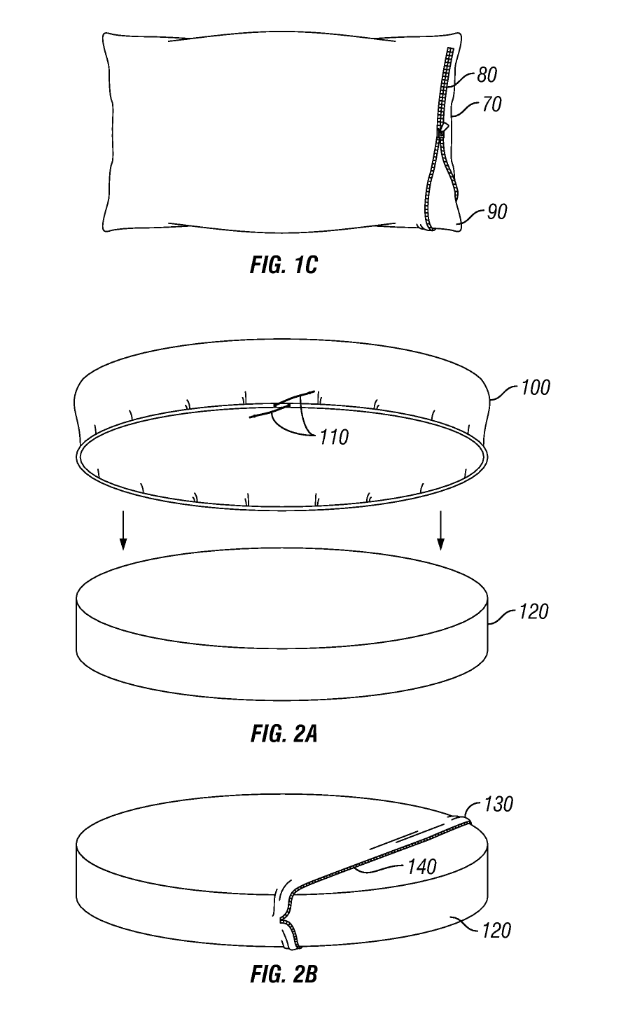

FIG. 1A shows an embodiment of mattress cover 10 comprising elastic edge 20 being disposed over mattress 30 and optionally box spring 40. FIG. 1B shows an alternative embodiment of mattress cover 50 comprising zipper 60 totally encasing mattress 30. FIG. 1C shows an embodiment of pillow cover 70 comprising zipper 80 totally encasing pillow 90. FIG. 2A shows an embodiment of pet bed cover 100 comprising drawstring 110 being disposed over pet bed 120. FIG. 2B shows an embodiment of pet bed cover 130 comprising zipper 140 totally encasing pet bed 120.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A bedding cover comprising:
a substantially waterproof material;
an adhesive applied to said material;
a chemical applied to said adhesive for repelling and/or killing one or more pests; and
a securing mechanism for securing said bedding cover to bedding;
wherein said bedding cover is disposable and/or recyclable.

2. The bedding cover of claim 1 wherein said adhesive is soy based and/or formaldehyde free.

3. The bedding cover of claim 1 wherein said chemical is substantially all-natural and/or EPA approved.

4. The bedding cover of claim 1 wherein said chemical is applied in powder form.

5. The bedding cover of claim 1 wherein said material comprises viscose.

6. The bedding cover of claim 1 wherein said securing mechanism comprises elastic or a drawstring.

7. The bedding cover of claim 1 wherein said drawstring comprises a bamboo-based fabric.

8. The bedding cover of claim 1 wherein said securing mechanism comprises a zipper and said bedding cover completely encloses said bedding.

9. The bedding cover of claim 1 further comprising a natural ink which biodegrades or changes color after a desired period of time.

10. A method of repelling or killing one or more pests, the method comprising the steps of:
applying an adhesive to a substantially waterproof material;
applying a pesticide to the adhesive, the material, adhesive, and pesticide forming a bedding cover;
drying the bedding cover;
securing the bedding cover to bedding; and
disposing of or recycling the bedding cover after a desired time period or number of uses.

11. The method of claim 10 wherein the step of applying the adhesive comprises spraying the adhesive on the material.

12. The method of claim 10 wherein the step of applying the pesticide comprises dusting on the pesticide in powder form.

13. The method of claim 10 wherein the step of applying the pesticide comprises applying one pound of pesticide per 1000 square feet of material.

14. The method of claim 10 wherein the securing step comprises tightening an elastic or drawstring.

15. The method of claim 10 further comprising the step of enclosing the bedding in the bedding cover, wherein the securing step comprises zipping the bedding cover closed.

16. The method of claim 10 further comprising the step of printing a biodegradable ink on the bedding cover, the ink changing color after the desired time period.

17. The method of claim 10 further comprising the step of producing a disposable shopping cart handle cover from the recycled bedding cover.
